(19) United States
(12) Patent Application Publication
(10) Pub. No.: US 2011/0136466 A1
(43) Pub. Date: Jun. 9, 2011

(54) Handheld Electronic Device with Emergency Functions Powered by Kinetic Energy

(76) Inventor: Yang Pan, Shanghai (CN)

(21) Appl. No.: 12/631,827

(22) Filed: Dec. 5, 2009

(51) Int. Cl. H04M 1/00; H04M 11/04; H04B 7/00

(52) U.S. Cl. 455/404.2; 455/404.1; 455/41.2; 455/574

(57) ABSTRACT

A handheld electronic device with emergency functions is disclosed. The device is powered by a battery for normal operations. A life-saving device is included in the device. The life-saving device is powered by a kinetic-energy-to-electrical-energy converter. The handheld device is capable of sending out a SOS type of message even if the battery runs out of the power. The electrical power is generated by the converter after the user actuates an input element of the converter. The input element may be implemented in various embodiments including a dedicated button, a plurality of piezoelectric devices installed on sidewalls of handheld device and a miniature dynamo. An alerting unit including one or a plurality of LED's may be employed to indicate an operational status of the device.

### CROSS-REFERENCE TO RELATED APPLICATIONS

This application is related to application Ser. Nos. 12/344,519, 12/508,611 and 12/626,900.

### BACKGROUND

1. Field of Invention

This invention relates to a handheld electronic device, specifically to a handheld electronic device with additional functionalities for a user in an emergency situation.

2. Description of Prior Art

A person may encounter many different dangerous situations during his or her life. For example, a person may be trapped under a mound of debris created by a fallen building during an earthquake or a terrorist attack. A rescue team is sent to fallen building to search for survivors. It is important for the rescue team to identify the location and status of the trapped person to save the person's life effectively. Although a mobile phone is becoming a popular handheld device, it may not be an effective communication device under a disaster situation. For example, the communication network may be destroyed during an earthquake. Further, a rescue task may take more than 1-2 weeks for a disaster such as an earthquake. The battery of the mobile phone may run out of power in a couple of days for most of devices.

Therefore, it is desirable to have a handheld electronic device, which can be used in an emergency situation to communicate with an external rescue station operated by a rescue team. The device should be able to generate electrical energy by itself to support the emergency use after a battery of the device runs out of the power. Further, the device should be able to communicate with the rescue station about the user's survival status even if the normal communication network is no longer available.

### SUMMARY OF THE INVENTION

According to one embodiment of the present invention, a handheld electronic device such as for example, a mobile phone may be integrated with additional functionalities for a user to communicate with an external rescue station in an emergency situation. The device comprises a short range communication unit conforming to the ZigBee standard in an exemplary case. The device further comprises a kinetic-energy-to-electrical-energy converter. As a result of the user's actuating of an input element of the converter, the electrical power is generated for the emergency communication. The input element of the converter may be a dedicated button for converting a pressure applied by the user into the electrical energy by the piezoelectric effects. The input element may also be a pair or a plurality of piezoelectric devices installed on sidewalls of the device. The converter may further be a miniature dynamo converting the device's motion induced by the user into the electrical power. The device powered by the kinetic-energy-to-electrical-energy converter sends a data file to the rescue station even if the battery for device runs out of the power. The file may include the user's identity and the user's location measured by a GPS (Global Positioning System).

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of a handheld electronic device including a life-saving unit illustrating the present invention;

FIG. 2 is a schematic diagram of a handheld electronic device using a dedicated button for receiving a user applied pressure;

FIG. 3 is a schematic diagram of a handheld electronic device using a pair of piezoelectric devices installed on the sidewalls of the handheld device;

FIG. 4 is a schematic diagram of a handheld electronic device using a miniature dynamo for converting the motion of the device induced by the user into the electrical energy;

FIG. 5 is a schematic functional block diagram of an exemplary handheld device including a life-saving unit;

FIG. 6 shows a schematic diagram that the life-saving unit of the handheld electronic device sends out a SOS type of message and triggers the rescue station to send out an acknowledgement message;

FIG. 7 shows a flow diagram illustrating a process of the communication between the life-saving unit of the handheld device and the rescue station.

FIG. 8 shows a flow diagram illustrating a process of the power management of the handheld electronic device including the life-saving unit.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

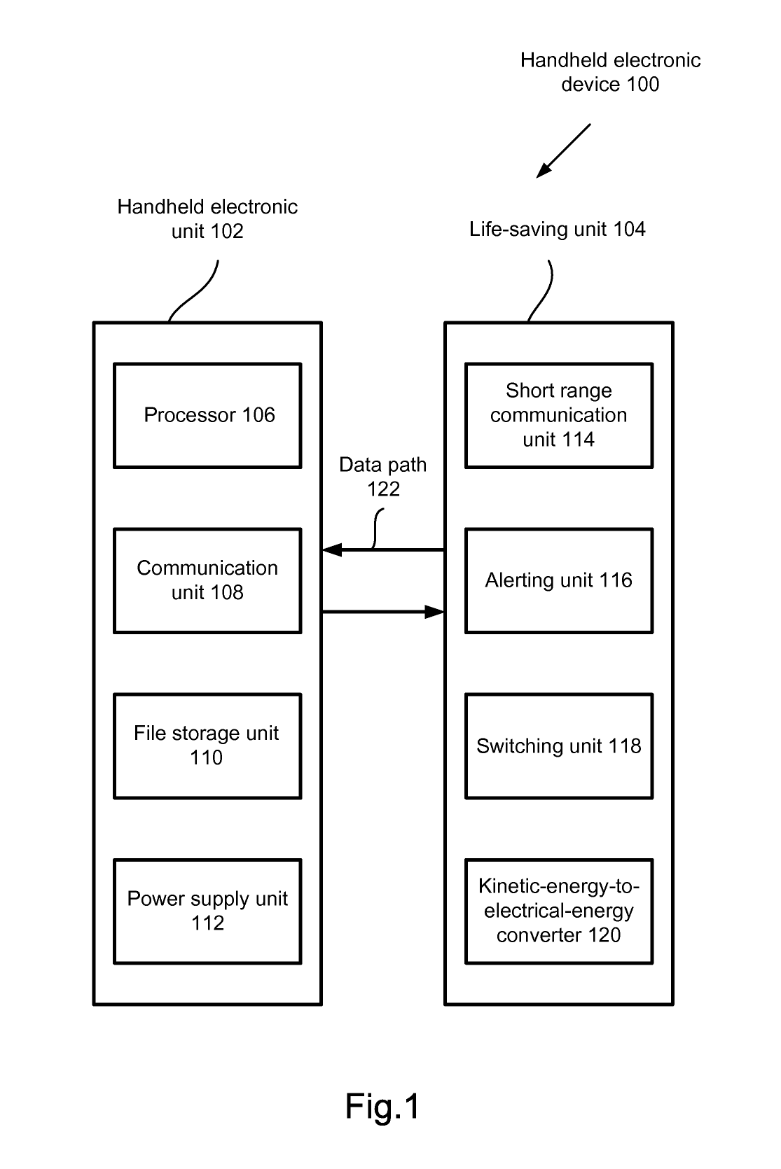

FIG. 1 is a schematic diagram of a handheld electronic device including a life-saving unit illustrating the present invention. The handheld electronic device 100 comprises a conventional handheld electronic unit 102 and a life-saving unit 104. The unit 102 further includes a processor 106 that pertains to a microprocessor or a microcontroller for controlling the operation of devices 102. According to one implementation of the present invention, the life-saving unit 104 may be controlled by the processor 106. According to another implementation of the present invention, the life-saving unit 104 may also be controlled by another processor associated with the unit 104. The processor may be a low-power microprocessor or microcontroller. The unit 102 may include a communication unit 108 for communicating through a conventional public phone network or through the Internet. The unit 102 may also include a file storage unit 110 for storing data files. The file storage unit 110 may comprise one or multiple semiconductor flash memories. The file storage unit 110 may also comprise other storage means such as for example, a magnetic storage device. A power supply unit 112 which is taken as a battery in an exemplary case is used to provide power for operations of 102. The unit 102 may also include other functional blocks such as input/output units, a media player and a digital image capture device.

The life-saving unit 104 further comprises a short range communication unit 114. It may form an ad hoc communication network with other similar devices. The communication unit 114 comprises a transceiver conforming to the ZigBee protocol in the preferred embodiment. ZigBee is the name of a specification for a suite of high level communication protocols using small, low-power digital radios based on the IEEE 802.15.4 standard for wireless personal area network (WPANs). The technology is intended to be simpler and less expensive than other WPANs, such as Bluetooth (IEEE 802.11b). ZigBee is targeted at radio frequency (RF) applications that require a low data rate, long battery life, and secure networking. The unit may also conform to other standards such as for example, the Bluetooth (IEEE 802.11), the WiFi (IEEE 802.11n) and the active RFID (Radio-Frequency-Identification).

The life-saving unit 104 may include an alerting unit 116. According to one implementation, the alerting unit 116 may be a LED (Light-Emitting-Diode). The on or off status of the LED and/or different displayed colors of the LED may correspond to different operational status of the device. In an exemplary case, the LED on a front surface of the device is on the “off” status when the device is operated in a normal status. The LED may be switched on with an indicative color when the device is operated in an emergency case. The LED may change to a different color when a SOS type of message is sent out. The LED may further change to yet another color when an acknowledgement message from the rescue station is received by the device. According to another implementation of the alerting unit 116, a short message related to the operation status of the device may be displayed on a display screen of the device. The display screen may be a LCD (Liquid Crystal Display) of the handheld unit 102. The display screen may also be a dedicated one with a smaller size comparing to the display screen of the handheld unit 102. The message may be an indicative one such as for example, “the device is in emergency mode” or “SOS message is sent out” or “rescue station received your message”.

The life-saving unit 104 may also include a switching unit 118. The user of the device may change the operation mode of the handheld device 100 by actuating the switching unit 118. The switching unit 118 may be implemented exemplarily as a dedicated button hidden in an enclosed area of the device. It may also be a hidden touchpad. It may further be an input instruction from the user to the device through the user input device to switch the operation mode of the device.

The life-saving unit 104 is powered by a kinetic-energy-to-electrical-energy converter 120. In an exemplary case, the converter 120 may comprise a piezoelectric device that generates electrical power through an induced strain or pressure by a finger of the user. The converter 120 further comprises a rectifier and a capacitor or a battery for storing the generated electrical power according to some implementations of the present invention. According to one embodiment, the input element is a dedicated button for receiving an applied pressure from the user. According to another embodiment, the input element is a pair of or a plurality of piezoelectric devices installed on sidewalls of the device.

In another embodiment, the converter 120 may be a miniature dynamo comprising a coil and a magnet with the movement of the movable user interface element causing the magnet to pass near or through the coil or causing the coil to pass near or over the magnet.

The data may be exchanged in between 102 and 104 through a data path 122. The user's identity and other personal data may be stored in the file storage unit 110 of the handheld electronic unit 102. The data may be readout and be sent out through the communication unit 114 in the emergency situation.

The device may also include a GPS (Global Positioning System). The GPS unit (not shown in the figure) may have already been included in the handheld electronic unit 102. The GPS unit may be added as a functional unit of the life-saving unit 104.

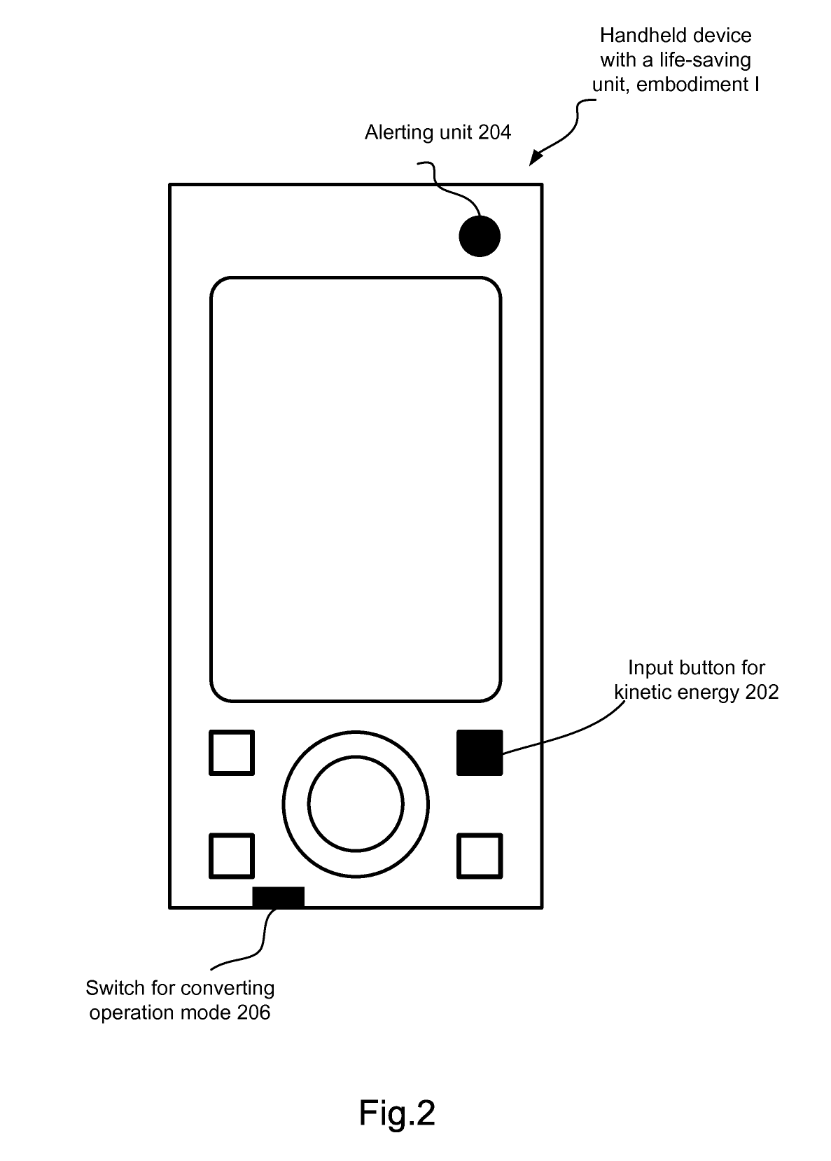

According to one embodiment of the present invention as illustrated in FIG. 2, the handheld device comprises a dedicated button 202 for receiving the kinetic energy (a pressure applied by a finger of the user). The button may be implemented in a different color or a different size from a convention one. The button 202 converts a user applied pressure into the electrical energy. The user may press the button 202 in a repeated manner in order to generate a sufficient amount of electrical energy to power the operation of the life-saving unit.

The alerting unit is implemented exemplarily as a lighting unit 204. It may be implemented as one or multiple LED's. The on/off status and/or colors of the LED(s) may be used to indicate different operational status of the device.

The switching unit is implemented exemplarily as a dedicated switch 206 enclosed in the bottom of the handheld device. The switch 206 may be contained in an enclosed space of the device with a cover. The user opens or moves the cover and actuates the switch. As a result, the operation mode of the device is changed.

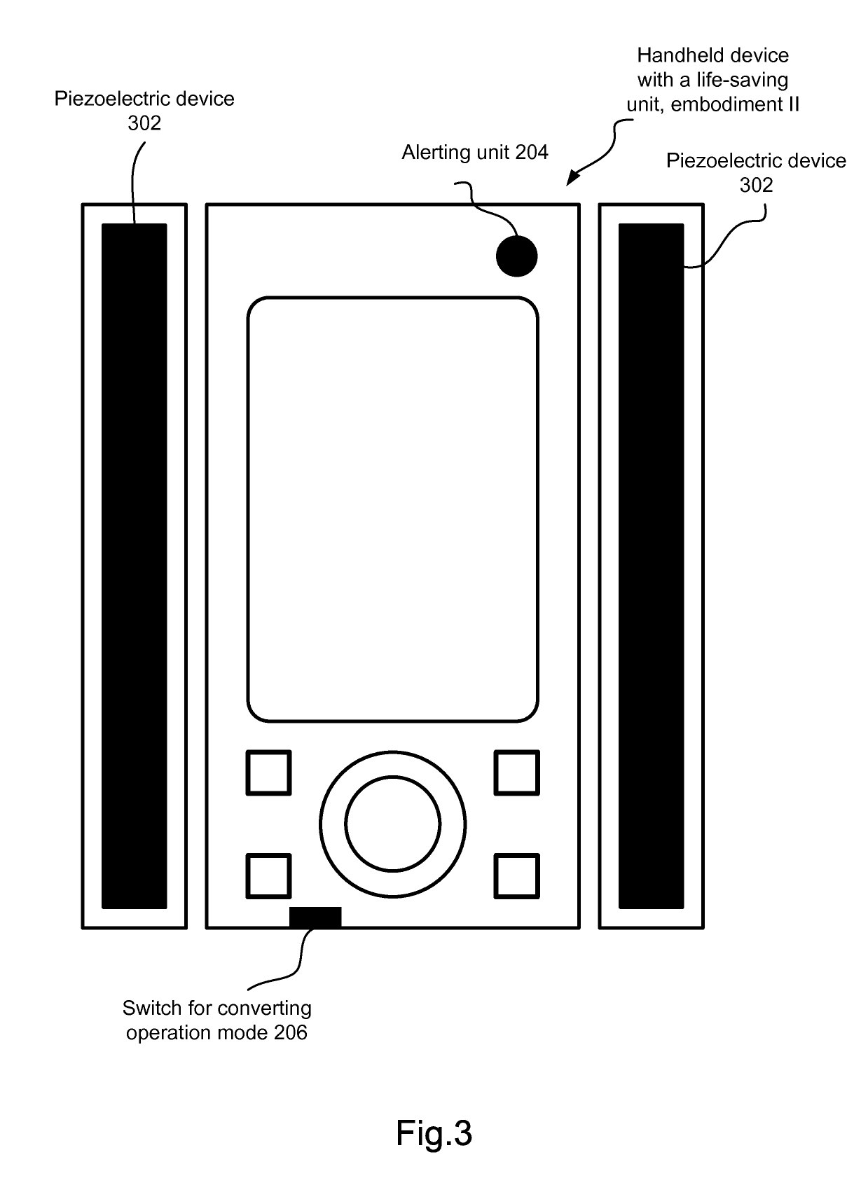

Another embodiment of the present invention is illustrated in FIG. 3. The dedicated button 202 is replaced by a pair of piezoelectric devices 302. The devices may be installed on the right and left sidewalls of the handheld device as illustrated in the figure. In the emergency situation when the battery power runs out, the user holds the device and applies the pressure to the piezoelectric device 302. As a result, the electrical power is generated by the device 302 by converting the pressure into the electrical energy. The user may squeeze the device in a repeated manner to generate the sufficient electrical energy to power the life-saving unit.

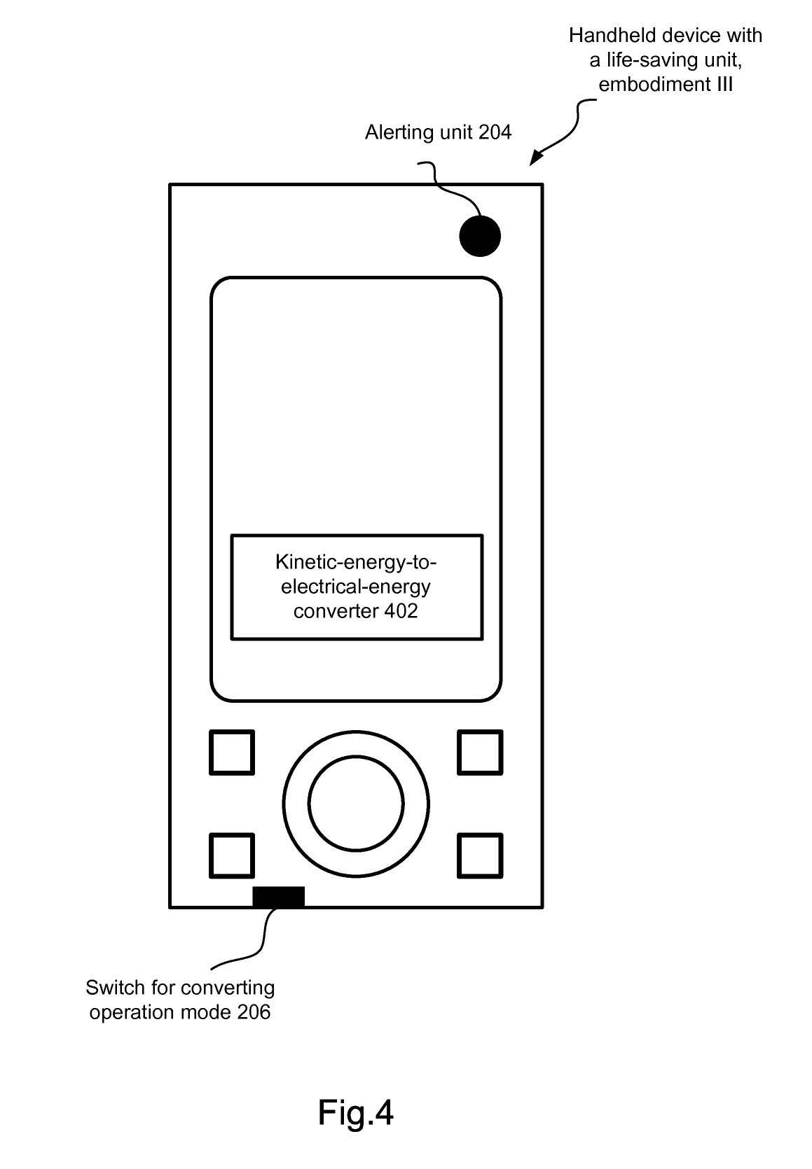

Yet another embodiment of the present invention is illustrated in FIG. 4. A miniature dynamo 402 is used to convert the kinetic energy into the electrical energy. The kinetic energy may be created by the motion of the device induced by the user. In an exemplary case, the user may hold the device and wave the device to generate the electrical power for the operation of the life-saving unit. The miniature dynamo 402 may comprise a coil and a magnet with the movement of the movable user interface element causing the magnet to pass near or through the coil or causing the coil to pass near or over the magnet.

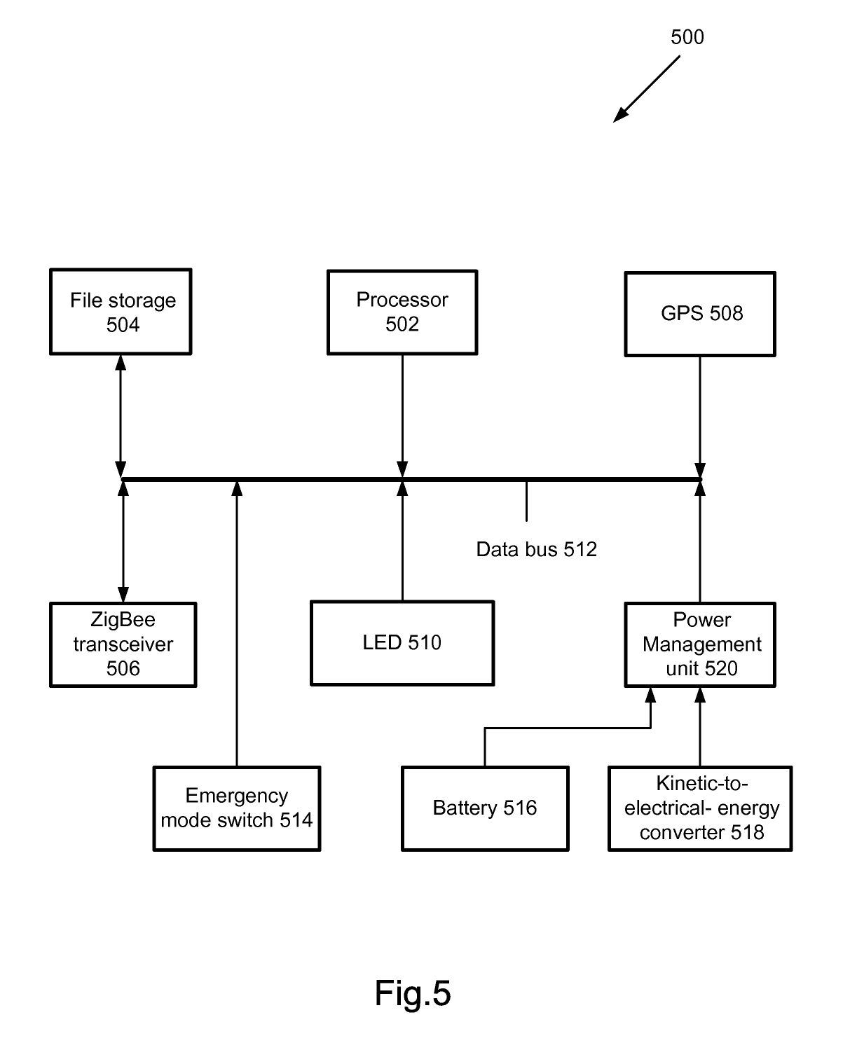

FIG. 5 is a schematic functional block diagram of an exemplary illustration of the handheld device including a life-saving unit. The exemplary device 500 includes a processor 502 that pertains to a microprocessor or a controller for controlling the overall operation of the device 500. The processor 502 may also include a DSP (Digital Signal Processor). The file storage unit 504 is, typically, a flash memory or a plurality of flash memories. The file storage unit 504 may also include a cache, for example, a Random-Access Memory (RAM) provided by semiconductor memory. The relative access time to the cache is substantially shorter than for the flash memories. The file storage unit 504 may also be a magnetic storage device.

The device 500 further includes a transceiver 306 that is taken as a ZigBee transceiver as an exemplary case. ZigBee is targeted at radio frequency (RF) applications that require a low data rate, long battery life, and secure networking. The device 500 may also include a GPS unit 508 as an option to determine the location of the person. Alternatively, the location can be determined by a zonal method for an ad hoc network formed by the multiple ZigBee devices.

A LED unit 510 is employed as the alerting unit of the device 500. The on/off status and/or different colors of the unit 510 may be used to indicate different operational status of the device. A data bus 512 is used to exchange data among different functional blocks of the device.

A switching unit 514 is employed to switch the device from the normal operation mode into the emergency operation mode or vice versa. The exemplary device 500 is powered by a battery 516 and/or a kinetic-energy-to-electrical-energy converter 518. The device 500 may employ one of or a combination of the three embodiments of kinetic-energy-to-electrical-energy conversion as described in FIGS. 2-4. A power management unit 520 may be employed to manage the power consumption of the device 500 in the normal operation or in the emergency operation. The power management unit 520 may switch off the normal functions of the handheld device and switch on the emergency functions if the battery power is below a predetermined value. The power management unit 520 may also switch the handheld device to a low power operation mode. If the battery power is running out, the power management unit 520 may automatically switch the device into the emergency operation mode as a life-saving device.

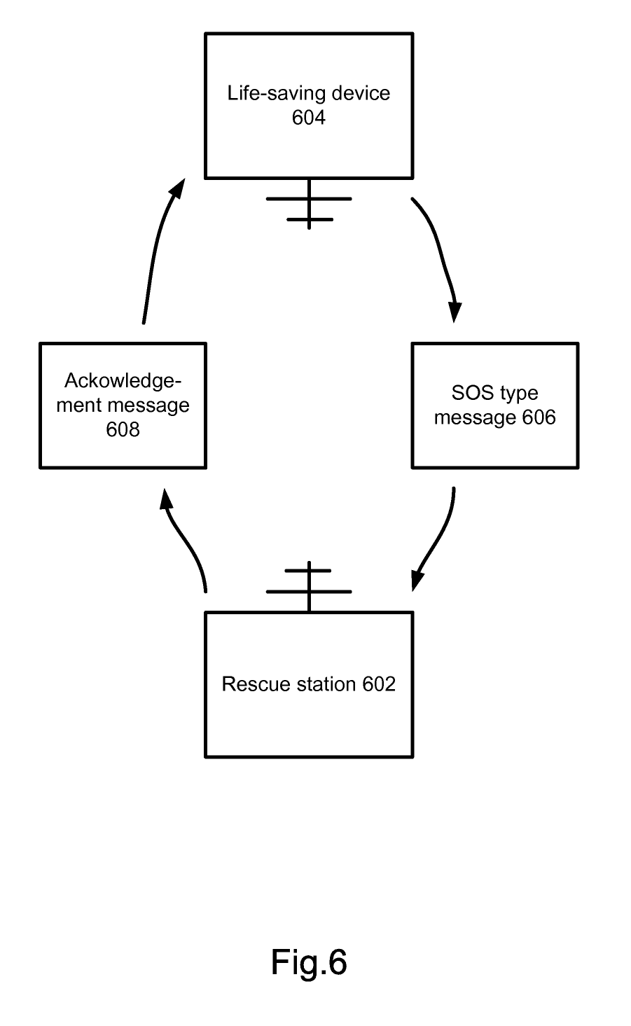

The interaction between a rescue station 602 and the handheld device as a life-saving device 604 in emergency is further illustrated in FIG. 6. The life-saving device 604 sends out a SOS type of message to the rescues station 602. The device 604 may be powered by the kinetic-energy-to-electrical-energy converter. The message may also include the user's personal data such as his or her identity. Since the life-saving device is powered by the kinetic energy generated from the user, the fact that the SOS message is received by the rescue station 602 indicates that the user is alive. The message may also include the person's location data determined by the GPS unit. The rescue station 602 receives the message and sends back an acknowledgement message. The life-saving device 602 receives the acknowledgement message and may alert the user by an alerting unit of the device. The communication between the life-saving device 604 and the rescue station 602 may be through an ad hoc communication network or link. The ad hoc communication network and link may conform to the ZigBee protocol in a preferred embodiment. The rescue station 602 may be a mobile station operated by a rescue team. The rescue station may also be an emergency-call number such as for example, “911” in some countries. The rescue station may also be a SMS (Short-Message-Service) or an email address. In such implementations, the communication unit of the life-saving device may be a conventional communication means including a means through a public phone/data network or through the Internet.

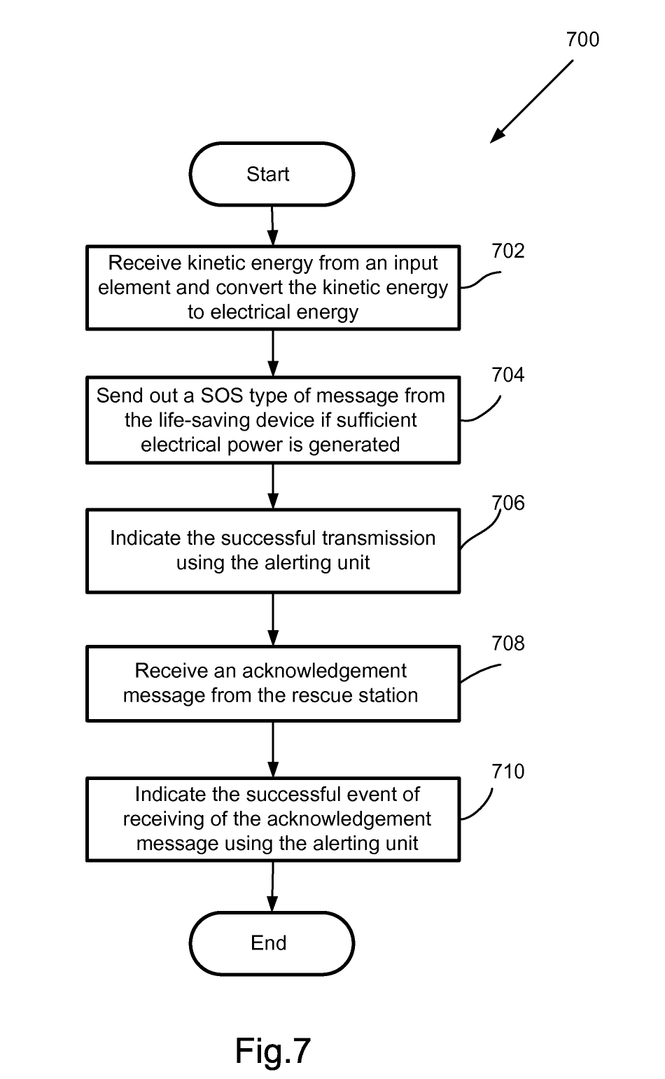

FIG. 7 shows a flow diagram of the communication between the life-saving device and the rescues station. Process 700 starts with a step 702 that the kinetic energy is received by an input element of the device and is then converted into the electrical energy by the kinetic-energy-to-electrical-energy converter. Three embodiments of the implementation have been discussed in previous sections. A SOS type of message is sent out by the device in step 704 after a sufficient electrical power is generated. The alerting unit of the device indicates the successful transmission of the message in step 706. The rescue station receives the message and transmits an acknowledgement message back to the device. In step 708, the device receives the acknowledgement message. The alerting unit indicates the successful receiving of the acknowledgement message in step 710.

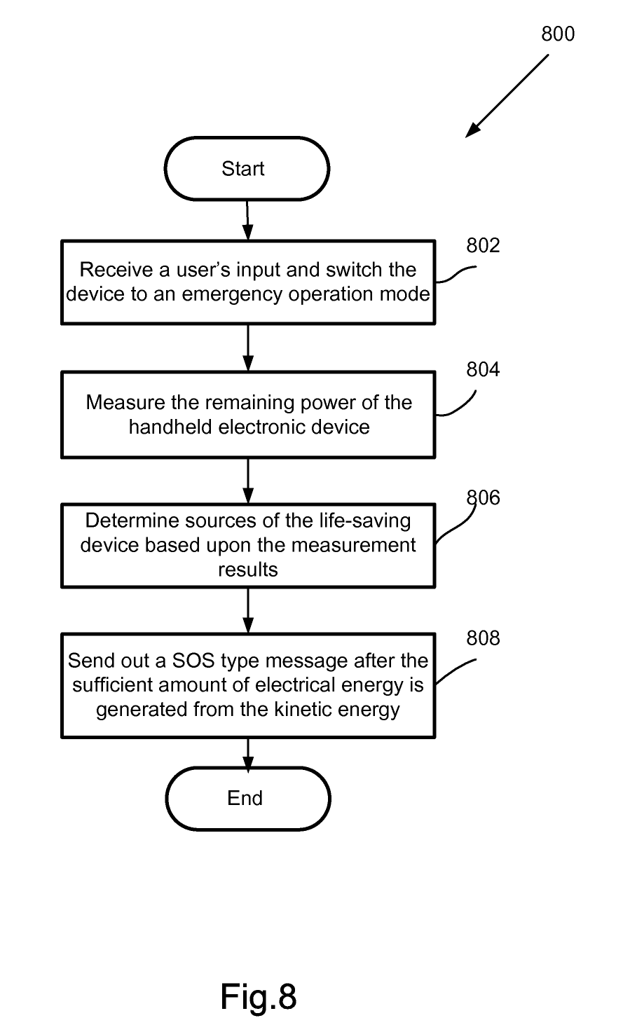

FIG. 8 shows a flow diagram of the operation of the power management of the handheld electronic device. Process 800 starts with step 802 that the device receives the user's input for switching the operation mode of the device from a normal one into the emergency operation mode. The remaining power of the battery is measured in step 804. Depending on the measurement results, the power supply sources for the operation of the life-saving device are determined in step 806. If the battery power is below a predetermined value, the life-saving device is powered solely by the kinetic-energy-to-electrical-energy converter. If the battery power is above the pre-determined value, the life-saving unit may be powered by the power generated from the kinetic-energy-to-electrical-energy converter in combination with the power from the battery. In step 808, the SOS type message is sent out using the device powered by the power source(s) determined in step 806.

While the invention has been disclosed with respect to a limited number of embodiments, numerous modifications and variations will be appreciated by those skilled in the art. It is intended that all such variations and modifications fall within the scope of the following claims:

1. A handheld electronic device for operating either in a normal operation mode as a conventional handheld device or in an emergency operation mode as a life-saving device, the device comprising:
a. a short range communication unit providing a means for communicating with another communication device through an ad hoc communication network;
b. a battery providing power for the device in the normal operation mode;
c. a kinetic-energy-to-electrical-energy converter providing power for the device in the emergency operation mode;
d. a switching means for switching the device in between said two modes; and
e. an alerting unit for indicating operation status of the device.

2. The device as recited in claim 1, wherein said kinetic-energy-to-electrical-energy converter further comprising one of or a combination of the following means:
a. a dedicated input element including a dedicated button for converting the user's applied pressure into the electrical energy;
b. a plurality of piezoelectric devices installed on sidewalls of the handheld electronic device for converting the user's applied pressure into the electrical energy; and
c. a dynamo for converting the user's induced motion into the electrical energy.

3. The device as recited in claim 1, wherein said switching means further comprising:
a. a dedicated input element including a button or a touchpad; and
b. an instruction through an input device of the handheld device.

4. The device as recited in claim 1, wherein said device further comprising a GPS (Global Positioning System) for determining the location of said device.

5. The device as recited in claim 1, wherein said communication unit conforming to a standard or a combination of standards from the following group:
a. ZigBee (IEEE 802.15.4 and its amendments);
b. Bluetooth (IEEE 802.11b and its amendments);
c. WiFi (IEEE 802.11 and its amendments); and
d. active RFID (Radio Frequency Identification).

6. The device as recited in claim 1, wherein said alerting unit further comprising one or a plurality of Light-Emitting-Diodes.

7. A method of communicating between a user in emergency and a rescue station by employing a handheld electronic device comprising a communication unit, a kinetic-energy-to-electrical-energy converter, a switching means for changing operation mode and an alerting unit, the method comprising:
a. switching the device to an emergency operation mode;
b. actuating an input element of said converter by the user to generate electrical energy; and
c. sending out a message.

8. The method as recited in claim 7, wherein said method further comprising a step of receiving an acknowledgement message by the handheld electronic device from the rescue station.

9. The method as recited in claim 7, wherein said operation of sending out a message may be through a communication network comprising:
a. an ad hoc communication network; and/or
b. a public communication network.

10. The method as recited in claim 9, wherein said public communication network further comprising a public telephone/data network and/or the Internet.

11. The method as recited in claim 7, wherein said communication unit comprising a short range communication device conforming to a standard or a combination of standards from the following group:
a. ZigBee (IEEE 802.15.4 and its amendments);
b. Bluetooth (IEEE 802.11b and its amendments);
c. WiFi (IEEE 802.11n and its amendments); and
d. active RFID (Radio Frequency Identification).

12. The method as recited in claim 7, wherein said operation of sending out a message including sending out a message to a dedicated emergency communication address.

13. The method as recited in claim 7, wherein the message further including the user's location determined by a GPS (Global Positioning System).

14. The method as recited in claim 7, wherein the message further including the user's identity and other personal data.

15. A method of managing power supplies of a hand held device comprising a battery as the first power supply source and a kinetic-energy-to-electrical-energy converter as the second power supply source, the method comprising:
a. supplying electrical power required by normal operations of the device from the battery; and
b. supplying electrical power required by emergency operations of the device from the converter.

16. The method as recited in claim 15, wherein said method further providing a means of switching the power supply between the battery and the converter triggered by a user's input through an input device.

17. The method as recited in claim 16, wherein said input device including a dedicated input element including a dedicated button or a dedicated touchpad.

18. The method as recited in claim 15, wherein said method further comprising a step of supplying a portion of electrical power from the battery in combination of the power generated from the converter for the emergency operations if the remaining power of the battery is in exceeding of a predetermined value.

19. The method as recited in claim 15, wherein said method further comprising a step of switching the handheld electronic device to a low power operation mode including switching off normal functionalities if the measured battery power is below a predetermined value.

20. The method as recited in claim 15, wherein said method further comprising a step of switching power supply source to the converter after the battery runs out of the power.
